(19) United States
(12) Patent Application Publication
(10) Pub. No.: US 2012/0037464 A1
(43) Pub. Date: Feb. 16, 2012

(54) DISK BRAKE FOR A RAILWAY VEHICLE HAVING AN ELECTRICALLY INSULATED BRAKE LINING RETAINER

(76) Inventor: Werner Stocker, Graz (AT)

(21) Appl. No.: 13/123,794

(22) PCT Filed: Sep. 7, 2009
(86) PCT No.: PCT/EP09/61530

§ 371 Date: Apr. 12, 2011

(30) Foreign Application Priority Data
Oct. 22, 2008 (AT) A1653/2008

(51) Int. Cl. B61H 5/00; F16D 55/224

(52) U.S. Cl. 188/72.9

(57) ABSTRACT

A disk brake for a railway vehicle is provided. The disk brake includes a brake disk, a brake caliper encompassing the brake disk, the brake caliper pressing a brake lining disposed on a brake lining retainer against the brake disk in case of actuation via a brake lever. The brake lever and the brake lining retainer are connected to each other by a hinged connection, wherein the brake lever and the brake lining retainer are electrically insulated from each other.

### CROSS REFERENCE TO RELATED APPLICATIONS

This application is the US National Stage of International Application No. PCT/EP2009/061530 filed Sep. 7, 2009, and claims the benefit thereof. The International Application claims the benefits of Austrian Application No. A1653/2008 AT filed Oct. 22, 2008. All of the applications are incorporated by reference herein in their entirety.

### TECHNICAL AREA

The present invention relates to a disk brake for a railway vehicle, with a brake disk, and a brake caliper which encloses the brake disk, where in the event of actuation by means of a brake lever a brake lining arranged on a brake lining retainer is pressed against the brake disk, where the brake lever and the brake lining retainer are connected by means of a hinged connection.

### PRIOR ART

In electrically driven railway vehicles it is possible to observe the phenomenon known as “vagabond currents”, that is to say electrical grounding or mass currents, which start to flow over largely unpredictable propagation paths between electrical structural units, or also between parts of the body itself. Frequently, too, these “vagabond currents” can only be controlled with a laborious grounding concept.

One possible cause of these “vagabond currents” are electrical leakage currents, which in a train in motion are fed from the rail to the wheel and thence via the brake caliper and the bogie, into the body when the disk brake is actuated.

“Vagabond currents” have also been observed in a stationary railway vehicle at the moment when another train passed the first on an adjacent track.

“Vagabond currents” can disrupt electronic equipment on board railway vehicles in that they cause it to issue error messages or even give rise to malfunctions. The safety of a railway vehicle can thereby be impaired.

This phenomenon is particularly disruptive in the case of high-speed trains. Firstly their bodies are made of light alloy and are particularly electrically conductive and secondly the brake linings of a high-speed train are generally manufactured from a metallic sintered material, which is likewise a good electrical conductor.

In order to prevent the dissemination of “vagabond currents”, efforts are made to eliminate where possible all feeding-in points and sources of interference occurring in a railway vehicle from the outset.

In order to prevent the feeding-in of electrical leakage currents from the rail into the bogie developments have seen a move towards electrical isolation of the fixing of the brake caliper on the bogie. However the brake caliper has a large mass, so that when running, the insulation is subjected to high levels of mechanical stress. This makes the embodiment of the electrical insulation laborious.

Attempts have also been made to eliminate the current path of a feeding-in by means of insulation of the brake linings. To this end the brake lining has been fixed to the brake lining retainer by means of an electrically insulating adhesive connection. However as the adhesive must resist high temperature loads during a braking operation, the adhesive connection is laborious.

### REPRESENTATION OF THE INVENTION

An object of the present invention is to specify a disk brake for railway vehicles, in which a feeding-in of an electrical leakage current from the rail into the body is prevented in the simplest possible manner.

This object is achieved by a disk brake according to the independent claim. Advantageous embodiments of the invention are defined in the dependent claims.

The inventive disk brake is characterized in that an electrical insulation is embodied between the brake lever and the brake lining retainer. This has the advantage that the weight of the components to be insulated is comparatively low. Regardless of whether the disk brake is embodied as a compact brake caliper, or as a suspension linkage brake caliper, the brake caliper, which has a mass of around 150 to 200 kg, is heavy in weight compared with the brake lining retainer, whose mass is only around 5 kg. As the component to be insulated has a comparatively low mass, the electrical insulation can be manufactured more cost-effectively. It is also beneficial that the electrical insulation is at a sufficient distance from the friction surfaces of the brake lining that it is subject to a lower heat effect during a braking procedure. The insulation material is thereby subjected to a lower temperature. The insulation effect can thereby be achieved with less effort. A further advantage of the invention can be seen in the fact that even when the brake lining is completely worn away and the brake lining retainer is in metallic contact with the disk brake, the insulation effect remains. A corresponding situation applies in the event of the loss of the brake lining.

A preferred embodiment of the invention can be constructed in such a way that the hinged connection has one or a multiplicity of insulation pieces, which insulate the brake lever and the brake lining retainer from each other. For an insulating embodiment of a hinged connection, the person skilled in the art basically has different design engineering options at their disposal.

In a simple embodiment such a construction can for example use bushing-shaped insulation pieces for this purpose.

An embodiment in which the hinged connection is embodied in the form of a rod hinge may be favorable from the constructional perspective.

The rod hinge is assembled with a first hinge part, which has first lugs, which are formed on the brake lining retainer on a side facing away from the brake lining and a second hinge part, which has second lugs, which are embodied at the end of the brake lever. Each first and second lug has a drilled hole in each case, which in an assembled state are arranged in alignment with each other, where a bushing is in each case fixed in drilled holes of the first and/or second lugs, which forms a bushing for a hinge rod which is passed through the same.

In order in a railway vehicle to maintain the insulation effect over the longest possible period of operation, it is favorable if the individual parts of the hinge are arranged at a distance from each other. This can be achieved in a simple manner in that a collar is in each case embodied at a frontal end of each bushing, which serves as a spacer between the hinge parts.

An arrangement is here favorable in which bushings lying adjacent to each other are in each case located opposite with their collar. Bridging of the insulation through abrasion of the disk brake is thereby counteracted. The electrical insulation between brake lever and brake lining retainer is maintained even after a long operating duration. This is of particular advantage in the case of high-speed trains, in which the abrasion can be electrically conductive.

The fixing of a bushing in such a lug can take place in a simple manner by means of a force fit.

Suitable materials for a bushing or an insulation disk are polymer materials and/or ceramic materials.

A temperature-resistant plastic is in particular favorable for manufacturing purposes. Such a plastic can for example be a polyimide or polytetrafluorethylene. Such materials are known under the trade-names KAPTON® and TEFLON®, available from makers Dupont. They are in a position to withstand temperatures of 280° C. and 350° C. respectively.

A preferred embodiment of the invention, in which the brake lining retainer is suspended on the bogie of the railway vehicle via a second hinged connection by means of a suspension linkage construction, is characterized in that this second hinged connection too is embodied in electrically insulating form. This makes it possible, in the case of this suspension linkage construction too, for the current path between rail and body to be interrupted. Such a suspension linkage brake caliper has the advantage that the braking force is transferred into the frame of the bogie almost exclusively via the suspension linkages. The strain on the brake lever is thereby reduced. According to the invention the brake lining retainer is electrically isolated from the bogie in the case of this construction too. Accordingly, the current path for the feeding-in of leakage currents is interrupted here too.

A favorable embodiment of a suspension linkage brake caliper in terms of manufacture can take a form such that insulation bushings or insulation disks are again used for the jointed connection between brake lining retainer and suspension linkage construction.

Regardless of whether the disk brake embodied in terms of its structure as a compact-brake caliper or as a suspension linkage brake caliper, one significant advantage of the invention can be seen in that a brake lining and/or a brake lining retainer can simply be changed, without the entire disk brake having to undergo renewed technical safety acceptance. Such an official approval is always time-consuming. A further significant advantage lies in the fact that a disk brake already in operation can be converted in a simple manner.

### BRIEF DESCRIPTION OF DRAWINGS

For further explanation of the invention, the next part of the description makes reference to the drawings, from which further advantageous embodiments, details and developments of the invention are evident.

FIG. 1 shows a first exemplary embodiment of the invention, where the disk brake is embodied as a compact caliper and where an electrical insulation is embodied between the jointed parts embodied as a hinge, which connect the brake lining retainer with the brake lever;

FIG. 2 shows a brake lining retainer represented in individual final, with the inventive arrangement of insulation bushings, seen from above;

FIG. 3 shows the brake lining retainer according to FIG. 2 in a side view, represented partially in cutaway form;

FIG. 4 shows a detailed representation of the hinged connection between brake lining retainer and brake lever in a cutaway form;

FIG. 5 shows a further embodiment of the invention, where the disk brake is embodied as a suspension linkage brake caliper and where the brake lining retainer is connected to the bogie by means of an H-shaped suspended construction;

FIG. 6 shows a further variant of a suspension linkage brake caliper, where the brake lining retainer is connected to the bogie by means of an I-shaped suspended construction;

FIG. 7 shows a further variant of the suspension linkage brake caliper, where the brake lining retainer is connected to the bogie by means of a Y-shaped suspended construction.

### EMBODIMENT OF THE INVENTION

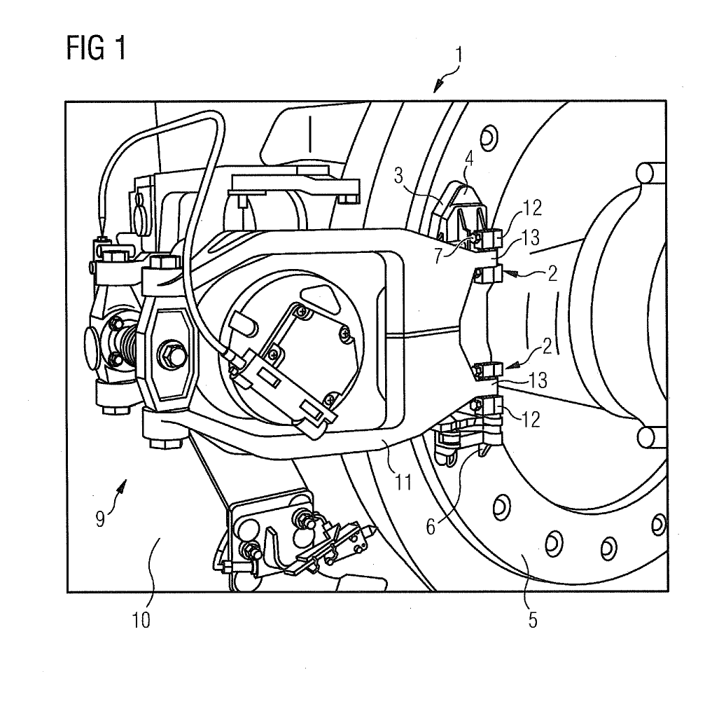

FIG. 1 shows a perspective view of an inventive disk brake 1 for a railway vehicle.

A brake caliper 9 is attached to the frame of the chassis by means of screws. The brake caliper 9 has an application device 10, which in the case of the actuation of the disk brake 1 by means of brake lever 11 acts upon a brake lining retainer 4 and thereby presses a brake lining 3 against the brake disk 5. The connection between the brake lever 11 and the brake lining retainer 4 is created by means of a hinged connection 7. This hinged connection 7 is embodied in the manner of a rod hinge. As can best be discerned below from the description for FIG. 4, the rod hinge 7 essentially comprises a hinge rod 6, which is passed through and drilled holes in fork-shaped lugs 12 or 13 respectively. The lugs 12 are here formed on the brake lining retainer 4, lugs 13 being embodied on the brake lever 11.

In the exemplary embodiment shown, each of the lugs 12 in each case forms a bearing block for the bushing 2. The bushings 2 are manufactured from plastic. This insulation between brake lever 11 and brake lining retainer 4 is comparatively simple, as the mass of brake lining 3 and brake lining retainer 4 (approx. 5 kg) is much lower compared with the mass of the brake caliper 9 (approx. 150 kg).

The fixing of the bushings 2 in a drilled hole of a lug 12 is effected by means of force fit. (It is however also possible for the insulating bushings 2 to be pressed into the drilled holes of the lugs 13).

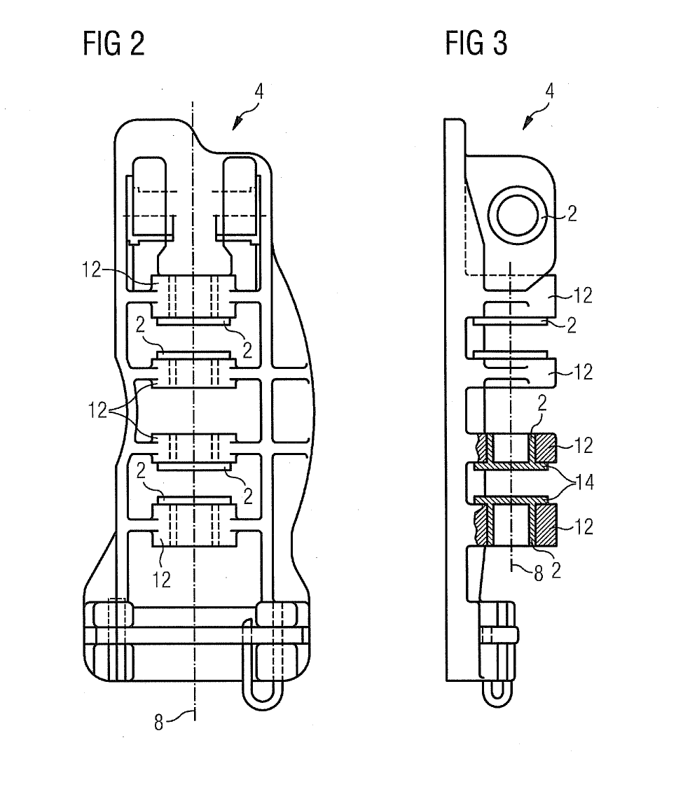

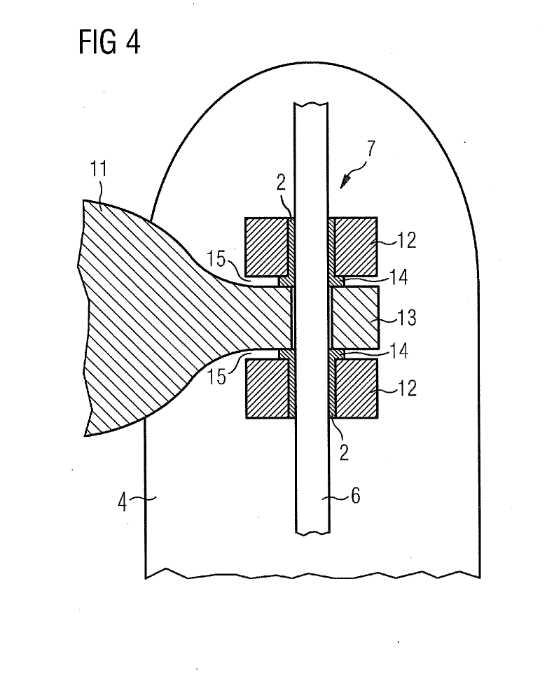

FIG. 2 shows the brake lining retainer 4 seen from above as an individual view; FIG. 3 shows the brake lining retainer 4 in a side view. According to the invention an insulation in the form of bushings 2 is embodied between the hinge rod 6 (see FIG. 4) and the brake lining retainer 4. Each bushing 2 has a collar 14 (FIG. 3). The bushings are in each case held in a drilled hole in the lug 12 by means of a force fit. The drilled holes are arranged in alignment along the axis 8. Each lug 12 forms a bearing block for a bushing 2. The arrangement is selected such that the respective bushings 2 in adjacently located lugs 12 are in each case opposite each other with their collar 14.

FIG. 4 shows in cutaway form a scrap view of the joint between the brake lever 11 and the brake lining retainer 4. The joint 7 essentially comprises, as already mentioned, the rod 6, which is mounted in insulating bushings 2 in the lugs 12 of the brake lining retainer 4. A lug 13 of the brake lever 11 in each case engages between adjacent lugs 12. A gap 15 is embodied axially between the lug 13 and the fork-shaped lugs 12, the width of which is in each case defined by the collar 14 of a bushing 2. It is thereby ensured that even after a long operating duration, deposits from abrasion of the brake linings do not result in bridging of the electrical insulation in gap 15.

FIGS. 5, 6, 7 in each case show variants of the invention, in which the brake lining retainer 4 is additionally connected to a bogie 28 by means of a suspension linkage construction 24, 25, 26. In a disk brake of this structural design, the braking force is directed almost completely via the suspension linkage construction 24, 25, 26 and the hinged connection 27 into the frame of the bogie 28. The fixing of the brake caliper needs essentially only to take up its own weight and the residual torque of the braking force.

In the embodiment in FIG. 5 the suspension linkages lie outside on the brake lining retainer, so that the electrical insulation can again be created in a simple manner by means of bushings 22 with a collar.

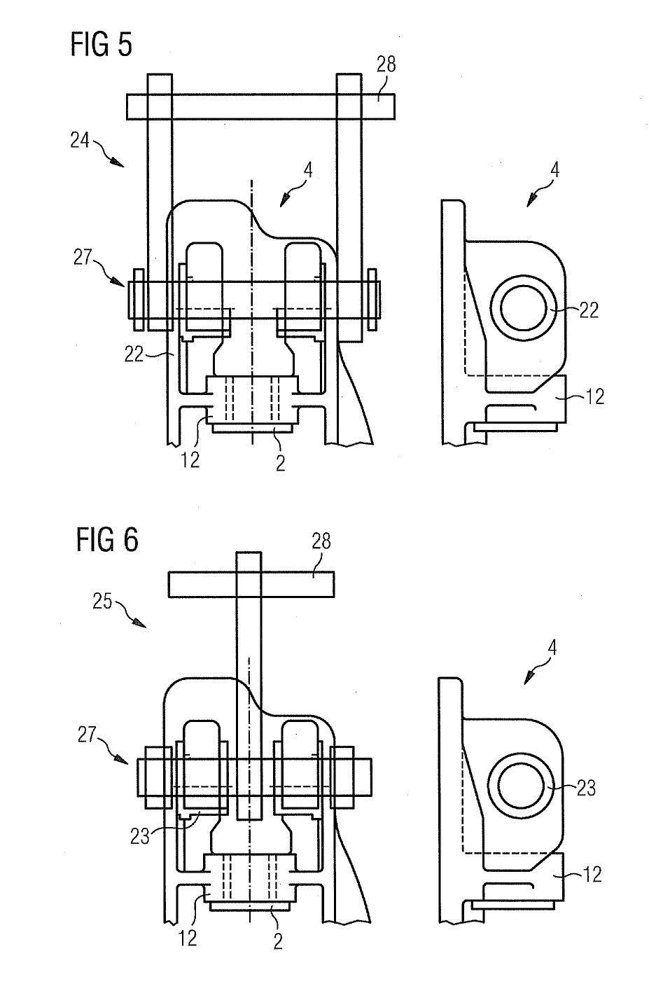

In the embodiment according to FIG. 6 an insulation disk 23 is in each case required externally because of the screws on the outer end of the horizontally arranged bolt of hinged connection 27.

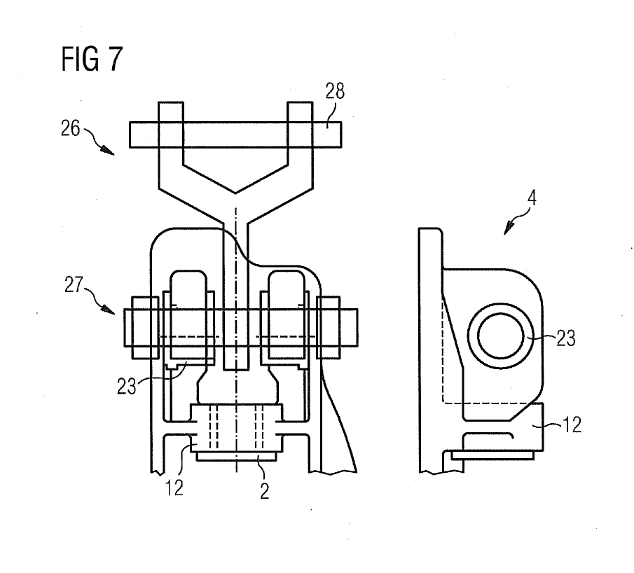

An externally located insulation disk 23 is provided in the case of the Y-shaped suspension linkage construction 26 represented in FIG. 7 too.

The insulation effect between the brake lining retainer 4 and the respective suspension linkage construction 24, 25, 26 can also be created by means of insulation bushings and insulation disks.

By means of the inventive disk brake, the feeding-in of leakage currents is effectively prevented both for the configuration with a compact caliper and for the construction 20 using a suspension linkage caliper, so that “vagabond currents” are less readily able to propagate. Both in the case of an embodiment as a compact caliper and with suspension linkage calipers, the electrical insulation of the brake lining retainer can be realized in a simple and cost-effective manner.

A further great advantage of the invention can be seen in the fact that disk brakes which are in operation can be simply converted. A time-consuming safety acceptance is not required, as ready-approved brake linings are used.

If is further advantageous that the insulation effect is also maintained in the case of severe abrasion of the brake lining; this applies even if the brake lining is abraded to below the permissible degree of wear.

1.-16. (canceled)

17. A disk brake for a railway vehicle, comprising:
a brake disk;
a brake caliper enclosing the brake disk;
a brake lever;
a brake lining arranged on a brake lining retainer; and
a hinged connection,
wherein the brake caliper, in an event of actuation, presses the brake lining arranged on the brake lining retainer via the brake lever against the brake disk,
wherein the brake lever and the brake lining retainer are connected via the hinged connection, and
wherein the brake lever and the brake lining retainer are electrically insulated from each other.

18. The disk brake as claimed in claim 17, wherein the hinged connection includes at least one insulation piece electrically isolating the brake lever and the brake lining retainer.

19. The disk brake as claimed in claim 18, wherein the at least one insulation piece is a bushing.

20. The disk brake as claimed in claim 19, wherein the hinged connection is a rod hinge.

21. The disk brake as claimed in claim 20, wherein the rod hinge comprises:
a first hinge part, which has first lugs formed on the brake lining retainer, on a side facing away from the brake lining; and
a second hinge part, which has second lugs embodied on an end of the brake lever,
wherein first and second lugs comprise drilled holes, which are arranged in alignment with each other, and
wherein bushings are in each case fixed in the drilled holes of the first and/or second lugs, and
wherein the bushings form a holding fixture for a hinge rod.

22. The disk brake as claimed in claim 21, wherein the holding fixture is a bearing bushing.

23. The disk brake as claimed in claim 21, wherein each bushing has a collar arranged on a frontal end of the bushing.

24. The disk brake as claimed in claim 23, wherein the bushings lying in lugs adjacent to each other, are in each case arranged opposite with their collar.

25. The disk brake as claimed in claim 21, wherein a fixing of the bushings in the drilled holes is created by a force fit.

26. The disk brake as claimed in claim 23, wherein a fixing of the bushings in the drilled holes is created by a force fit.

27. The disk brake as claimed in claim 18, wherein each bushing comprises polymer material.

28. The disk brake as claimed in claim 18, wherein each bushing comprises ceramic material.

29. The disk brake as claimed in claim 27, wherein each bushing has a wall thickness greater than 2 mm.

30. The disk brake as claimed in claim 28, wherein each bushing has a wall thickness greater than 2 mm.

31. The disk brake as claimed in claim 23, wherein the collar of a bushing has an axial width greater than 2 mm.

32. The disk brake as claimed in claim 27, wherein each bushing comprises a polyimide or polytetrafluorethylene.

33. The disk brake as claimed in claim 17, wherein the brake lining retainer is suspended on a bogie of the rail vehicle via a second hinged connection and a suspension linkage construction, wherein an electrical insulation is embodied between the brake lining retainer and the suspension linkage construction.

34. The disk brake as claimed in claim 33, wherein the electrical insulation between the brake lining retainer and the suspension linkage construction is created by a bushing comprising an insulation material.

35. The disk brake as claimed in claim 34, wherein the second hinged connection is a rod hinge.
